(19) United States
(12) Patent Application Publication
(10) Pub. No.: US 2022/0082856 A1
(43) Pub. Date: Mar. 17, 2022

(54) Flexible Nose Pad Assembly for Eyewear

(71) Applicant: Brent SHELDON, (US)

(72) Inventors: Brent SHELDON, Miami Beach, FL (US); Guy BROUSSEAU, JR., Marieville (CA)

(21) Appl. No.: 17/535,184

(22) Filed: Nov. 24, 2021

Related U.S. Application Data
(63) Continuation of application No. PCT/CA2020/051458, filed on Oct. 29, 2020.
(60) Provisional application No. 62/935,255, filed on Nov. 14, 2019.

(51) Int. Cl. G02C 5/12

(52) U.S. Cl. CPC G02C 5/122; G02C 5/126

(57) ABSTRACT

There is provided an adjustable nose pad system for eyewear comprising a holding prong and a nose pad. The holding prong can be affixed to a nose bridge portion of an eyewear frame. A flexible nose pad can be mounted to the holding prong. The holding prong can be constructed from a rigid material and comprises a groove on a first surface and a protrusion on a second surface opposite the first surface. The groove and protrusion work together to provide the adjustability of the nose pad system. In this regard, the holding prong, together with the nose pad can be flexed from one side to another to provide a comfort fit to the user.

### CROSS-REFERENCE TO RELATED APPLICATIONS

The present application is a continuation of International PCT Application No. PCT/CA202/051458 filed on Oct. 29, 2020, which claims priority from U.S. Provisional Application No. 62/935,255 filed on Nov. 14, 2019, both of which are incorporated herein by reference in their entireties.

### TECHNICAL FIELD

The following relates to nose pads for eyewear, and methods of assembling eyewear having flexible nose pads.

### BACKGROUND

Eyewear such as eyeglasses generally include a frame that supports one or more lenses. The frame typically includes a nose bridge or nose pieces that engage the user's nose to support the eyewear on the user's head. Eyeglasses also typically include a pair of arms attached to (or integral with) the frame, to further support the eyeglasses, e.g. by resting the arms on the user's ears or engaging their head in the temple region. The nose pieces which engage the user's nose typically include nose pads which provide friction to the eyewear to prevent it from slipping off the user's nose.

Eyeglasses have traditionally utilized frames or frame components made from substantially rigid materials such as plastics, metals, or composite materials. To ensure a proper fit, nose pads can typically be adjusted to conform around a user's nose. Nose pads generally comprise a flexible pad mounted on a rigid holder. A drawback of the rigid holder is that the nose pad can only typically withstand some flexure and can be prone to breakage or deformation.

Furthermore, various challenges can arise in construction, assembly, and use when incorporating flexible elements. For instance, the assembly associated with using multiple different materials can be complex and expensive. Components made of rigid material and components made of flexible material generally can find difficulties adhering to each other, and may require a joining mechanism that should be easy to assemble while also being durable and provide a strong joint. Joining the flexible pad to the holder can be difficult and the pad may unintentionally fall off the holder.

It is an object of the following to address at least one of the above-noted disadvantages.

### SUMMARY

In one aspect, there is provided an adjustable nose pad system for eyewear comprising a holding prong and a nose pad. The holding prong can be affixed to a nose bridge portion of an eyewear frame. A flexible nose pad can be mounted to the holding prong. The holding prong can be constructed from a rigid material and comprises a groove on a first surface and a protrusion on a second surface opposite the first surface. The groove and protrusion work together to provide the adjustability of the nose pad system. In this regard, the holding prong, together with the nose pad can be flexed from one side to another to provide a comfort fit to the user.

In another aspect, there is provided a method of producing the adjustable nose pad system. In yet another aspect, there is provided a method of producing eyewear comprising the adjustable nose pad system described above. In an implementation, the nose pad is secured to the holding prong by the insertion of a fastener, such as cured resin. In another implementation, the flexible nose pad is overmolded over the holding prong.

### BRIEF DESCRIPTION OF THE DRAWINGS

Embodiments will now be described with reference to the appended drawings wherein:

FIG. 1 is a rear perspective view of eyewear with a flexible nose pad system;

FIG. 2 is an enlarged perspective view of the eyewear with a flexible nose pad system shown in FIG. 1;

FIG. 3 is a perspective view of the holding prongs of the flexible nose pad system;

FIG. 4 is a perspective view of the holding prongs of the flexible nose pad system showing the groove and protrusion;

FIG. 5 is a rear view of the holding prongs shown in FIG. 4;

FIG. 6 is a rear view of the holding prongs shown in FIG. 5, with transparency to illustrate flexibility;

FIG. 7 is a rear view of the flexible nose pad system; and

FIG. 8 is a rear view of the flexible nose pad system, with transparency to illustrate flexibility.

### DETAILED DESCRIPTION

A flexible nose pad assembly can be utilized to provide a comfort-fit in eyewear such as eyeglasses, sunglasses, safety eyewear and the like. Rigid holding prongs can be at least partially contained or embedded in a flexible nose pad body to provide attachment points to lens retainers in the eyewear, with the flexible nose pad body therebetween allowing flexibility of the nose pad at or about the user's nose.

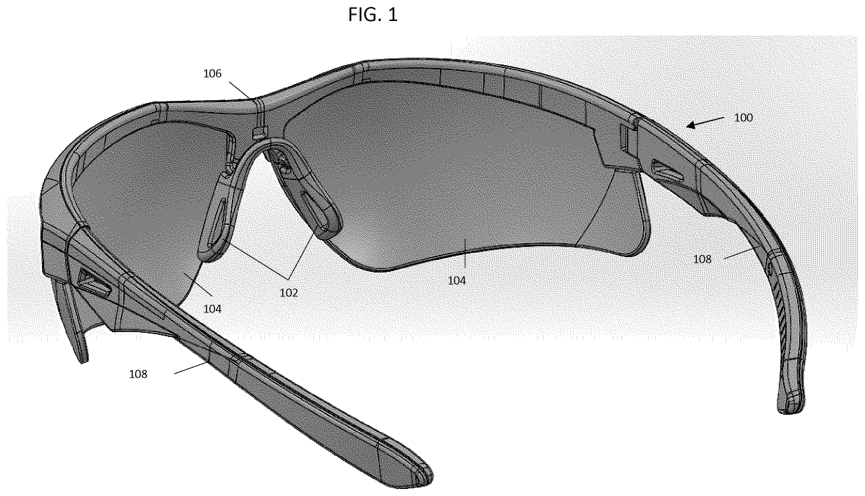

Turning now to the figures, FIG. 1 provides a rear perspective view of an assembled eyewear 100, also referred to interchangeably herein as an eyewear assembly 100 or eyewear 100 for brevity. The eyewear 100 includes a frame 106, arms 108 and a pair of lenses 104. The eyewear 100 also includes a pair of nose pads 102. The nose pads 102 engage the user's nose and provide friction so that the eyewear 100 stays on the user's nose without slipping. The nose pads 102 are generally made from a resilient rubber to provide comfort to the user at the same time as providing enough resistance to slipping. Adjustable nose pads are highly desirable to ensure the eyewear 100 fits snugly on the user's nose.

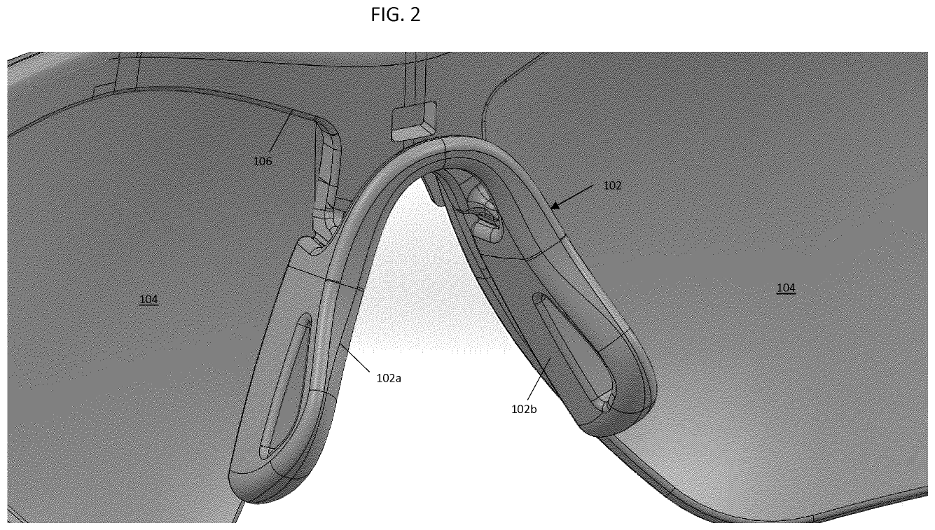

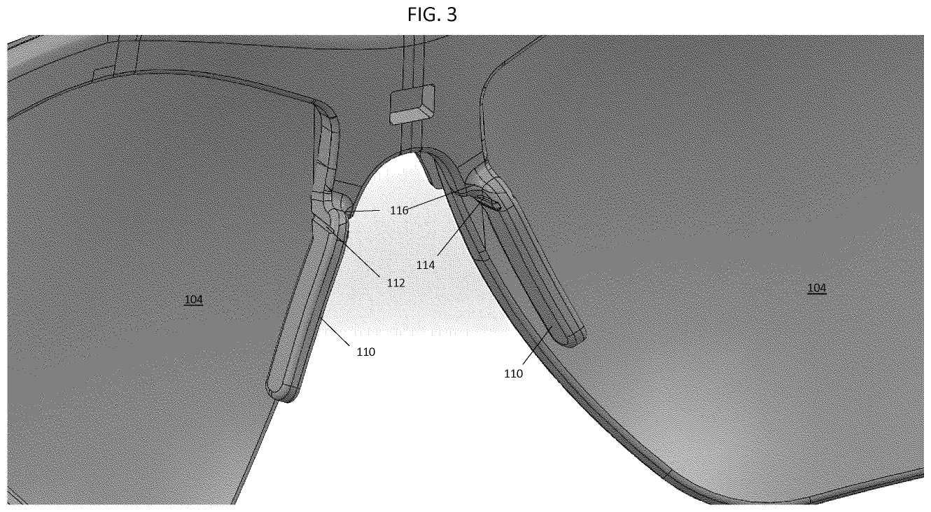

FIG. 2 shows an enlarged perspective view of the eyewear 100 with the flexible nose pads 102. In this embodiment, the nose pads 102a, 102b are a singular nose pad portion 102 attached to the eyewear frame 106. The nose pad portion 102 can be overmoulded to a holding prong (FIG. 3) extending from the frame 106.

FIG. 3 shows a perspective view of the holding prongs 110 of the flexible nose pad system. The holding prongs 110 extend from the frame 106. The holding prongs 110 can be formed from a rigid material such as plastic, wood, acetate, or another suitable rigid material. The holding prongs 110 can act as a substrate for the over moulding process.

The construction of the flexible nose pad assembly can be done using any suitable overmolding process. Overmolding, sometimes referred to as two times injection molding, is a process where a single part is created using two or more different materials in combination. Typically, the first material (or substrate) is partially or fully covered by overmolded material during the manufacturing process. In this case, the holding prongs 110 act as the substrate that is overmolded with the material used to create the nose pads 102. The material that forms the overmolded nose pads 102 can be overmolded on the holding prongs 110 to create the flexible nose pad assembly that can then be joined to the frame 106 in constructing the eyewear 10.

The overmolded material is generally an elastomer such as thermoplastic polyurethane (TPU), rubber or thermoplastic rubber (TRP), soft plastic, or any other suitable material. As the nose pads 102 will bear against the user's nose, it is preferably to use a material which is softer to the touch. At the same time, it is also preferable that the overmoulded material be resilient and provide frictional resistance. It can be appreciated that the flexible material can be overmolded to the holding prongs 110 prior to attaching the holding prongs 110 to the frame 106. That is, nose pad system (holding prong 110 and nose pad 102) can be constructed as a separate component that is incorporated into the assembly process. It is also possible to first attach the holding prongs 110 to the frame 106, and then overmould the flexible nose pad material to the frame assembly.

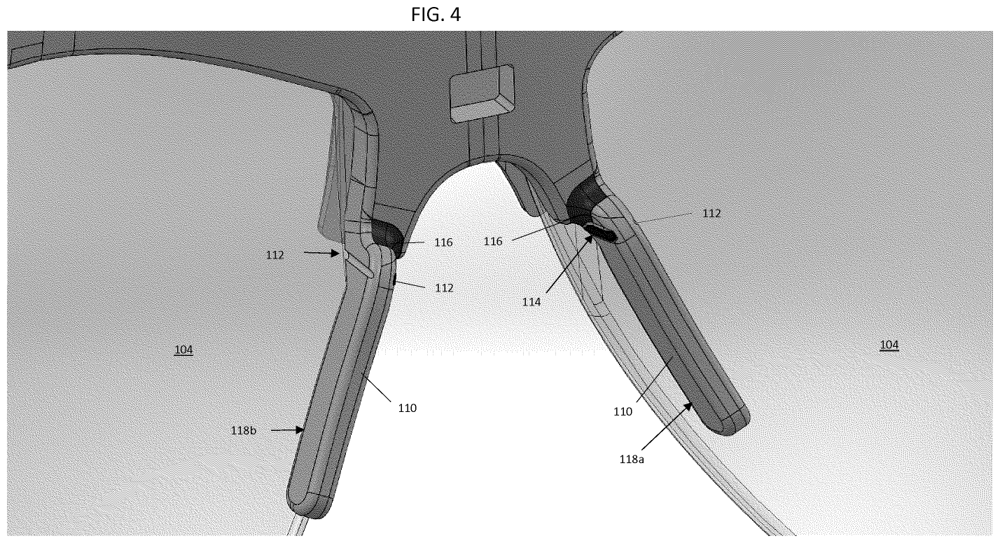

FIG. 4 shows the details of the holding prongs 110. The holding prongs 110 comprise details to provide adjustability to the nose pad assembly. The adjustability of the nose pad system is precise and controlled, and dependent on the details on the holding prongs 110. The holding prongs 110 can generally comprise a long rectangular body. Each holding prong has 2 surfaces, a first surface 118a which faces the user's nose, and a second surface 118b which faces away from the user's nose. The surfaces 118b facing away from the user's nose comprise a groove 112 which extends the width of the holding prong 110. On the opposite surface 118a, a protrusion 114 can be formed. The groove 112 and protrusion 114 work together to provide the adjustability of the nose pad system. In this regard, the holding prong 110, together with the nose pad 102 can be flexed from one side to another to provide a comfort fit to the user. The groove 112 and protrusion 114 details added to the prong 110 create a defined location on the prong 110 from which location the nose pad 102 will be adjustable.

The groove 112 defines a weakness in the structure of the holding prong 110 to ensure that upon deformation, it will deform from that area. The protrusion 114 defines a strength in the structure of the holding prong 110 to ensure that the prong will not tear off after multiple adjustments of the nose pads. Furthermore, the holding prong 110 also comprises a curved portion 116 which increases the strength of the holding prong 110 to ensure it will not deform from that location by the user.

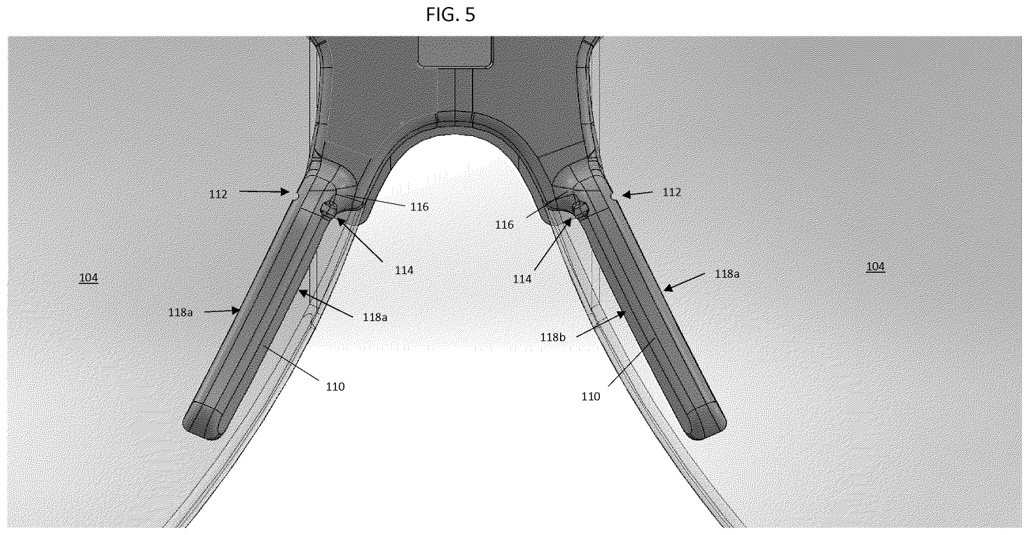

FIG. 5 provides a rear view of the holding prongs shown in FIG. 4. From this angle it can be seen that each holding prong 110 comprises a first surface 118a which faces the user's nose, and a second surface 118b which faces away from the user's nose. The surfaces 118b facing away from the user's nose comprise a groove 112. On the opposite surface 118a, a strengthening protrusion 114 can be formed.

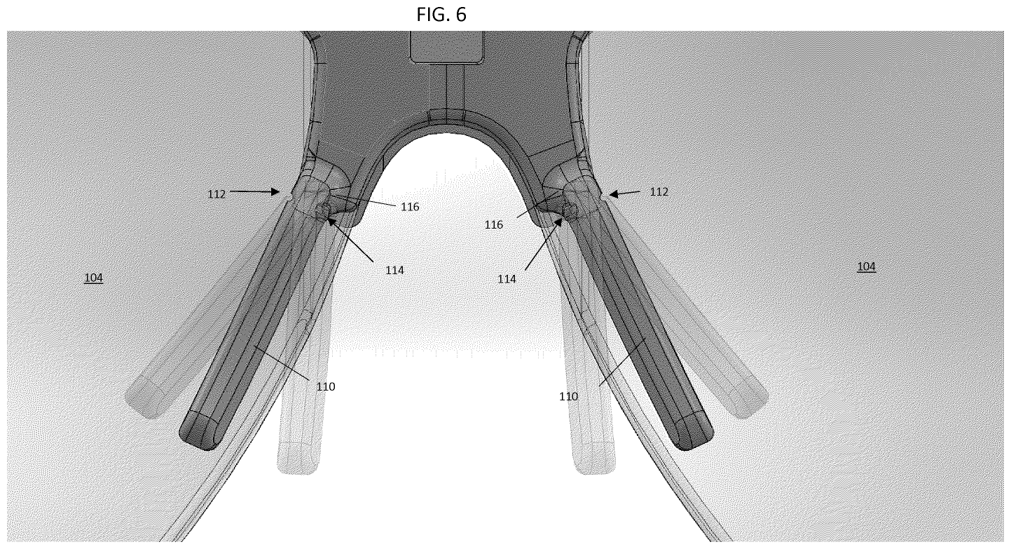

FIG. 6 shows a rear view of the holding prongs shown in FIG. 5, with transparency to illustrate flexibility. The groove 112 provides flexibility and adjustability to the nose pad system. As it can be seen from FIG. 6, the holding prong 110 flexes and deforms at the location of the groove 112 and the protrusion 114. The groove 112 defines a weakness in the structure of the holding prong 110 to ensure that upon deformation, it will deform from that area. The protrusion 114 defines a strength in the structure of the holding prong 110 to ensure that the prong will not tear off after multiple adjustments of the nose pads.

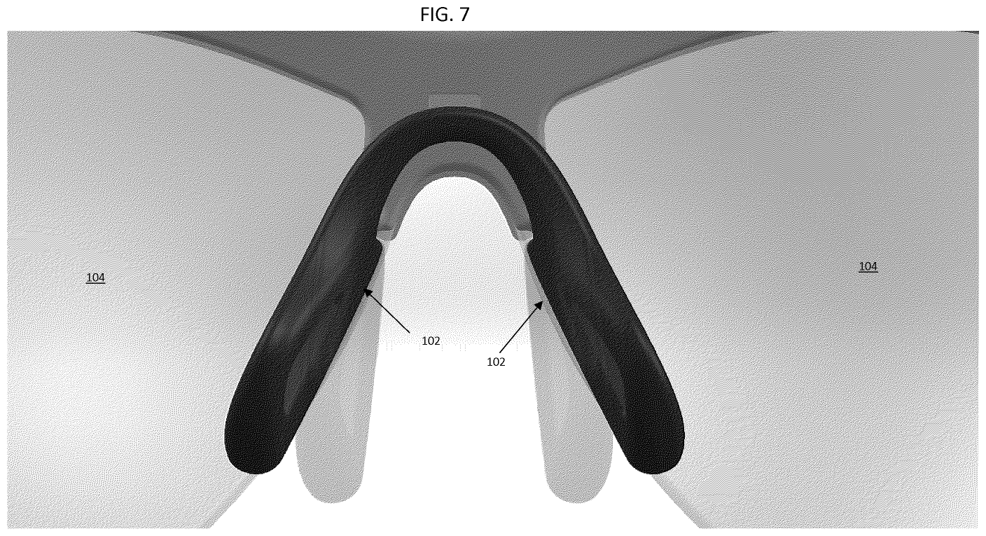

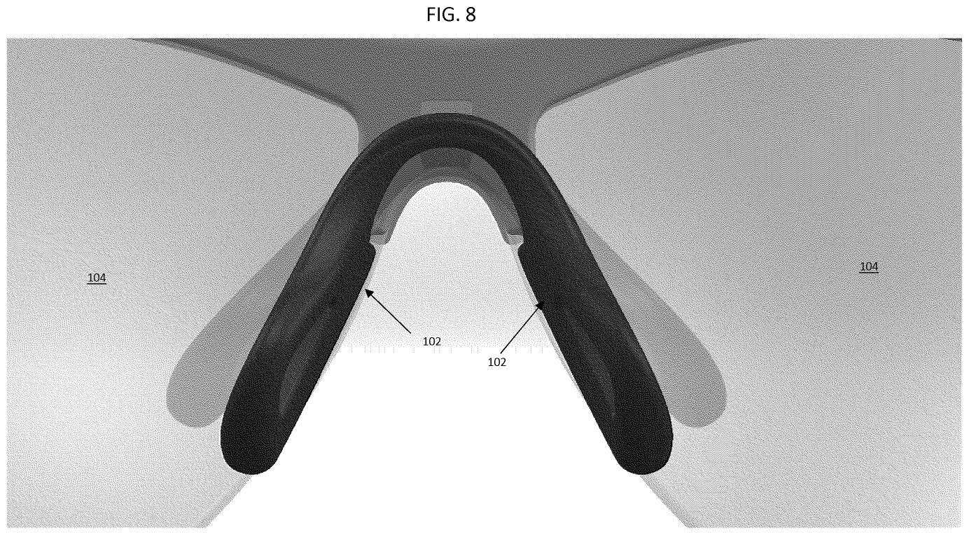

FIG. 7 and FIG. 8 show a rear view of the flexible nose pad system, with transparency to illustrate flexibility. The rigid holding prongs 110 enable the nose pads 102 to be flexed such that the nose pads 102 attached thereto can be bent or otherwise separated or twisted relative to each other. This allows, for example, a user to slightly flex the nose pads 102 towards each other, if they have a smaller nose, as shown in FIG. 7. In another instance, a user may slightly flex the nose pads 102 away from each other, if they have a larger nose, as shown in FIG. 8. The flexibility of the nose pads 102 allows the eyewear to be worn comfortably by the user, allowing for a snug fit.

The flexible nose pads 102 may be constructed from an elastomer such as thermoplastic polyurethane (TPU), rubber or thermoplastic rubber (TRP), soft plastic, or any other suitable material. Holding prongs 110 may be made from plastic, wood, acetate, or another suitable rigid material. The flexible nose pad assembly and holding prongs 110 can be joined to each other using fasteners or an overmoulding process. The holding prongs 110 in this example are relatively thinner than the flexible nose pads 102 to allow them to be at least partially embedded or contained therein.

It can be appreciated that holding prongs 110 can be constructed with slots, notches or recesses to receive the overmoulding material. The holding prongs 110 can be shaped or contoured to increase adhesion during the overmoulding process.

It can be appreciated that the eyewear 100 can be assembled by overmoulding the nose pads 102a, 102b or the nose pad portion 102 to the holding prongs 110. The frame 106 can be formed as a single injected part having holding prongs 110 attached thereto.

General fasteners may be used to attach the holding prongs 110 to the frame 106. In an alternate embodiment, fasteners such as screws, dowels, adhesive, rivets or any suitable fastening device may be used as well.

The groove 112 can be formed by milling a groove on the surface of the holding prong. Any suitable method of forming a groove in a rigid material may be used. The protrusion 114 can be formed by welding or creating a single injected holding prong 110 having a protrusion 114. Any suitable method of creating a protrusion on a rigid material may be used, including fastening.

The material that forms the overmolded nose pads 102 can be overmolded on the holding prongs 110 to create the flexible nose pad assembly that can then be joined to the frame 106 of the eyewear 100. The overmolded material is generally an elastomer such as thermoplastic polyurethane (TPU), rubber or thermoplastic rubber (TRP), soft plastic, or any other suitable material.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures, and components have not been described in detail so as not to obscure the examples described herein. Also, the description is not considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

Although the above principles have been described with reference to certain specific examples, various modifications thereof will be apparent to those skilled in the art as outlined in the appended claims.

1. A flexible nose pad assembly for eyewear comprising:
a pair of holding prongs; and
a pair of nose pads attached to the holding prongs;
wherein the holding prongs comprise:
a first surface having a width;
a second surface opposite the first surface;
a groove disposed on the first surface; and
a protrusion extending outwardly from the second surface.

2. The assembly of claim 1, wherein the pair of nose pads are attached to the pair of holding prongs using an overmoulding process.

3. The assembly of claim 2, wherein the groove extends the width of the holding prong.

4. The assembly of claim 3, wherein the pair of holding prongs and the pair of nose pads can be flexed relative to one another.

5. The assembly of claim 4, wherein the nose pads are constructed from an elastomer.

6. The assembly of claim 5, wherein the holding prongs are constructed from a rigid material.

7. A method of constructing a flexible nose pad assembly for eyewear comprising:
forming a pair of holding prongs; and
attaching a pair of nose pads to the holding prongs;
wherein the holding prongs comprise:
a first surface having a width;
a second surface opposite the first surface;
a groove disposed on the first surface; and
a protrusion extending outwardly from the second surface.

8. The method of claim 7, wherein the pair of nose pads are attached to the pair of holding prongs using an overmoulding process.

9. The method of claim 8, wherein the pair of nose pads are constructed from an elastomer.

10. The method of claim 9, wherein the holding prongs are constructed from a rigid material.

11. Eyewear comprising:
A frame;
A pair of arms extending from the frame;
A pair of lens attached to the frame; and
a nose pad assembly;
the nose pad assembly comprising:
a pair of holding prongs; and
a pair of nose pads attached to the holding prongs;
wherein the holding prongs comprise:
a first surface having a width;
a second surface opposite the first surface;
a groove disposed on the first surface; and
a protrusion extending outwardly from the second surface.
